(19) United States
(12) Patent Application Publication
(10) Pub. No.: US 2008/0239330 A1
(43) Pub. Date: Oct. 2, 2008

(54) Image processing apparatus, image forming apparatus and computer-readable medium

(75) Inventor: Jun Sato, Saitama (JP)

Correspondence Address: OLIFF & BERRIDGE, PLC, P.O. BOX 320850, ALEXANDRIA, VA, 22320-4850, US

(73) Assignee: FUJIXEROX CO., LTD., TOKYO (JP)

(21) Appl. No.: 11/984,388

(22) Filed: Nov. 16, 2007

(30) Foreign Application Priority Data
Mar. 29, 2007 (JP) 2007-089558

(51) Int. Cl. G06F 3/12

(52) U.S. Cl. 358/1.1

(57) ABSTRACT

An image processing apparatus includes a reception unit, a first character recognition unit, a reduction processing unit, a second character recognition unit, a status detecting unit and a process content changing unit. The reception unit receives image information. The first character recognition unit recognizes character information from the image information received. The reduction processing unit performs a reduction process for the image information received. The second character recognition unit recognizes character information from the image information for which the reduction processing unit performs the reduction process. The status detecting unit detects a relation between the character information recognized by the first character recognition unit and the character information recognized by the second character recognition unit. The process content changing unit changes a process content of the reduction process performed by the reduction processing unit, according to the relation detected by the status detecting unit.

### CROSS-REFERENCE TO RELATED APPLICATIONS

This application is based on and claims priority under 35 U.S.C. §119 from Japanese Patent Application No. 2007-89558 filed Mar. 29, 2007.

### BACKGROUND

1. Technical Field

The invention relates to an image processing apparatus, an image forming apparatus, and a computer-readable medium.

2. Summary

According to an aspect of the invention, an image processing apparatus includes a reception unit, a first character recognition unit, a reduction processing unit, a second character recognition unit, a status detecting unit and a process content changing unit. The reception unit receives image information. The first character recognition unit recognizes character information from the image information received by the reception unit. The reduction processing unit performs a reduction process for the image information received by the reception unit. The second character recognition unit recognizes character information from the image information for which the reduction processing unit performs the reduction process. The status detecting unit detects a relation between the character information recognized by the first character recognition unit and the character information recognized by the second character recognition unit. The process content changing unit changes a process content of the reduction process performed by the reduction processing unit, according to the relation detected by the status detecting unit.

### BRIEF DESCRIPTION OF THE DRAWINGS

Exemplary embodiments of the invention will be described in detail below with reference to the accompanying drawings, wherein:

FIG. 1 is a view showing the configuration of a system to which an exemplary embodiment of the invention may be applied;

FIG. 2 is a block diagram showing the functional configuration of a controller according to a first exemplary embodiment of the invention;

FIG. 3 is a flow chart showing an operation of the controller according to the first exemplary embodiment of the invention;

FIG. 4 is a view showing a specific example of changing a parameter or a processing method in the first exemplary embodiment of the invention;

FIG. 5 is a block diagram showing the functional configuration of a controller according to a second exemplary embodiment of the invention;

FIG. 6 is a flow chart showing an operation of the controller according to the second exemplary embodiment of the invention;

FIG. 7 is a view showing a specific example of changing a parameter in the second exemplary embodiment of the invention; and

FIG. 8 is a hardware configuration diagram of a computer to which the exemplary embodiments of the invention may be applied.

### DETAILED DESCRIPTION

Herein below, exemplary embodiments of the invention will be described in detail with reference to the accompanying drawings.

First, a system to which this exemplary embodiment is applied will be described.

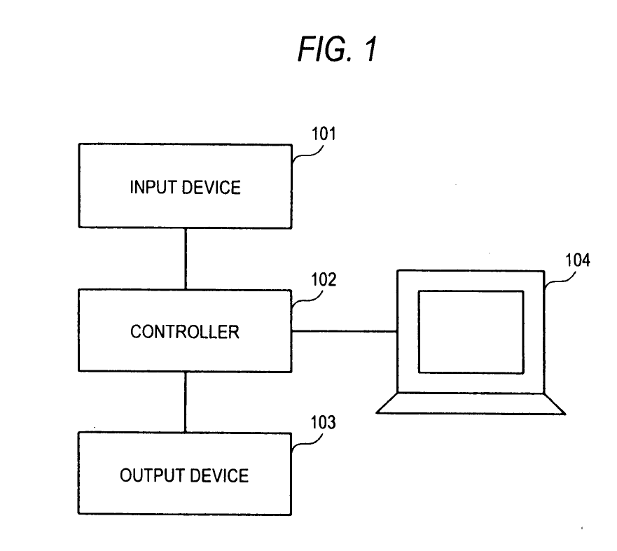

FIG. 1 shows an example of the configuration of a system to which this exemplary embodiment may be applied.

As shown in the figure, this system includes an input device 101 for inputting image information, a controller 102 for processing the image information, an output device 103 for outputting the processing result of the image information, and a client 104 for giving an instruction to the controller 102.

The input device 101 inputs the image information by, for example, reading an image printed on an original document sheet. In this exemplary embodiment, the input device 101 is provided as an example of an image reading device. The input device 101 may be, for example, a scanner, of a CCD type in which the original document sheet is irradiated with light from a light source and the reflected light is reduced by a lens and received by CCD (Charge Coupled Device), or of a CIS type in which the original document sheet is irradiated with light from a LED light source sequentially and the reflected is received by a CIS (Contact Image Sensor).

The controller 102 performs image processing based on the image information input from the input device 101 or the image information input from the client 104, and outputs the result to the output device 103. In this exemplary embodiment, the controller 102 is provided as an example of an image processing apparatus. In particular, in this exemplary embodiment, a reduction process in which the image information is reduced in size according to a size of a recording medium is performed as the image processing. For example, in the case of reduction printing in which image information prepared according to a size of a certain recording medium is printed on a recording medium having a smaller size, a print file sent from the client 104 is imaged while being reduced in size, and is output to the output device 103. Also, for example, in the case of reduction copying in which image information read from a recording medium having a certain size is printed on a recording medium having a smaller size, image information input from the input device 101 is reduced in size and output to the output device 103. It is noted that, in this exemplary embodiment, the term “reduction process” includes all processes in which an image is reduced in size eventually, such as not only a process of simply reducing an A3-size image into an A4-size image but also a process of reducing an image by increasing the number of pages allocated in a single recording medium.

The output device 103 forms an image on a recording medium based on the result of the image processing performed by the controller 102. The output device 103 is, for example, a printer, which may be of an electrophotographic type in which a toner adhered to a photoreceptor is transferred to a recording medium to form an image, or of an ink-jet type in which an ink is ejected onto a recording medium to form an image. The recording medium may be of any material so long as an image is printable thereon. Its representative example is paper, but it may be an OHP sheet, a metal plate, a cloth, and the like. In this exemplary embodiment, an apparatus including the controller 102 and the output device 103 is an example of an image forming apparatus.

The client 104 is a computer terminal that is operated by a user for giving instructions relating to the image processing to the controller 102. The client 104 may be, for example, a PC (Personal Computer).

In the figure, the input device 101 and the controller 102, the controller 102 and the output device 103, and the controller 102 and the client 104 are connected respectively by communication lines. Here, examples of the communication lines include LAN (Local Area Network) and the Internet. It is noted, however, that the system configuration in which the devices are connected by communication lines is merely one illustrative example. The system may be such that at least one of a set of the input device 101 and the controller 102, a set of the controller 102 and the output device 103, and a set of the controller 102 and the client 104 is integrated.

As described above, when image information that is generated according to a recording medium having a certain size is printed on a recording medium having a smaller size or when an image is copied from an original document sheet having a certain size to a recording medium having a smaller size, the image is reduced in size and output. At that time, almost no problem arises when the image includes only graphics such as photographs. However, when the image contains characters, such a problem may arise that the characters cannot be read. Here, how easy a character can be read is determined depending on not only a font of the character but also factors such as a background of the character. Therefore, it is necessary to satisfy a sensuous criterion such as whether or not a character is readable or whether or not a character is easy to read. Accordingly, in this exemplary embodiment, character recognition for performing OCR (Optical Character Reader) is used in order to determine a criterion as to whether or not a character can be read quantitatively or whether or not a character is easy to read quantitatively.

Specifically, in printing, after a print file is converted into a reduced image, the character recognition is performed for the reduced image, and a recognition rate is calculated by verification with the characters contained in the print file. If the recognition rate is lower than a specified value, image conversion based on the print file is performed with parameters or a process method being changed, and when the recognition rate exceeds an expected recognition rate, the image is output.

In copying, the character recognition is performed both (i) before the image reduction and (ii) after the image reduction, and the results of the both are compared to calculate the recognition rate. If the recognition rate is lower than a specified value, the image is reduced with parameters being changed, and when the recognition rate exceeds an expected recognition rate, the image is output.

Hereinbelow, the case of reduction printing will be described as a first exemplary embodiment in more detail, and the case of reduction copying will be described as a second exemplary embodiment in more detail.

### FIRST EXEMPLARY EMBODIMENT

First, the configuration of the controller 102 in the first exemplary embodiment will be described.

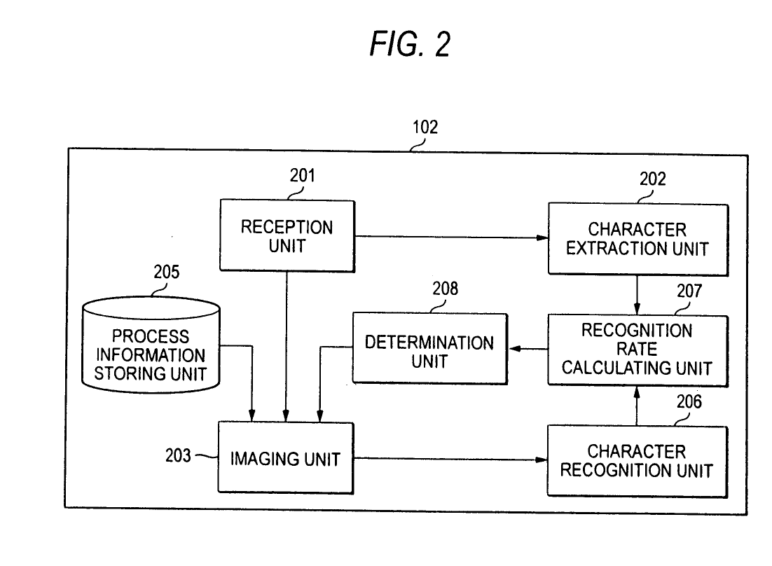

FIG. 2 is a diagram showing the configuration of the controller 102.

In this exemplary embodiment, the controller 102 includes a reception unit 201 for receiving a print file, a character extraction unit 202 for extracting character information from the print file, and an imaging unit 203 for generating an image of the print file and generating a reduced image. Also, the controller 102 includes a process information storing unit 205 for storing information that specifies a process content of the imaging unit 203 (hereafter referred to as “process information”), and a character recognition unit 206 for recognizing character information from the reduced image generated by the imaging unit 203. Furthermore, the controller 102 includes a recognition rate calculating unit 207 for calculating a recognition rate by comparing the character information extracted by the character extraction unit 202 and the character information recognized by the character recognition unit 206, and a determination unit 208 for determining, based on the recognition rate, either (i) that the reduced image generated by the imaging unit 203 is output as it is or (ii) that a reduced image should be generated again with the process information being changed.

The reception unit 201 receives a print file from the client 104, for example, as an example of the image information. In this exemplary embodiment, the reception unit 201 is provided as an example of a reception unit. Also, the print file is used as an example of the information relating to an object and/or a drawing that is described using numerical values. Examples of the print file include PDL (Page Description Language). This print file contains information relating to an output size of the image as header information, for example. In addition, the characters to be output as an image are specified in the form of character code.

The character extraction unit 202 extracts the character code contained in the print file received by the reception unit 201, as character information. In other word, the character extraction unit 202 performs the character recognition from the print file. In this exemplary embodiment, the character extraction unit 202 is provided as an example of a first character recognition unit and as an example of a character extraction unit. The character extraction unit 202 also extracts information relating to print positions of the characters together when extracting the character information.

The imaging unit 203 performs imaging by, for example, rendering the print file. In this exemplary embodiment, the imaging unit 203 is provided as an example of an imaging unit. Also, at this time, the image is reduced to a size specified by the header information of the print file. That is, the imaging unit 203 also serves as an example of a reduction processing unit in this exemplary embodiment.

The process information storing unit 205 stores parameters for use in reduction of an image and the information defining the process method of the imaging, as process information that specifies the process contents in the imaging unit 203. Here, examples of the parameters for use in reduction of an image include a density of a background image (hatch pattern or the like) and an emphasis degree of an edge of a character or a region contained in the image information. Examples of the process method of the imaging include a method of changing a typeface (font etc.) of a character. Further, the process information storing unit 205 adds information of selection order to the process information and stores the resulting information. This selection order may be determined, for example, according to a pattern (type) of misrecognition obtained as a result of the character recognition. That is, the selection order may be such that a font to be used next when misrecognition of a certain pattern occurs with the use of a certain font. In addition, the information of such selection order may be determined for each type of printers.

The character recognition unit 206 performs T/I separation (separation of a character region and a region other than characters) for the reduced image generated by the imaging unit 203, and recognizes character information from the character region. In this exemplary embodiment, the character recognition unit 206 is provided as an example of a second character recognition unit and as an example of a character recognition unit. The character recognition unit 206 also recognizes information relating to the print positions of the characters when recognizing the character information.

The recognition rate calculating unit 207 compares the character information extracted by the character extraction unit 202 and the character information recognized by the character recognition unit 206, and calculates the recognition rate. Here, the term “recognition rate” refers to a match ratio between the character information extracted by the character extraction unit 202 and the character information recognized by the character recognition unit 206. For example, for the print position of each character, score “1” is given if the character extracted by the character extraction unit 202 is recognized by the character recognition unit 206, whereas score “0” is given if the character extracted by the character extraction unit 202 is not recognized by the character recognition unit 206. Then, the total of the scores for all the print positions is obtained, and the resulting value is divided by the number of the print positions. The value thus obtained is employed as the recognition rate. In this exemplary embodiment, the recognition rate is used as an example of a relation between character information recognized by the first character recognition unit and character information recognized by the second character recognition unit. In addition, the recognition rate calculating unit 207 is provided as an example of a status detecting unit for detecting this relation (a status of recognition).

The determination unit 208 compares the recognition rate calculated by the recognition rate calculating unit 207 with a reference value that is an example of a predetermined threshold value. If the recognition rate is equal to or greater than the reference value, the determination unit 208 instructs the imaging unit 203 to output the image at that time. Also, if the recognition rate is less than the reference value, the determination unit 208 instructs the imaging unit 203 to generate a reduced image again with the process information being changed. In this exemplary embodiment, the determination unit 208 is provided as an example of a process content changing unit. It is noted that the determination unit 208 here changes a subsequent process depending on which the recognition rate is less than the reference value or equal to or greater than the reference value. Alternatively, the determination unit 208 may change a subsequent process depending on which the recognition rate is greater than the reference value or equal to or less than the reference value.

Next, the operation of this exemplary embodiment will be described.

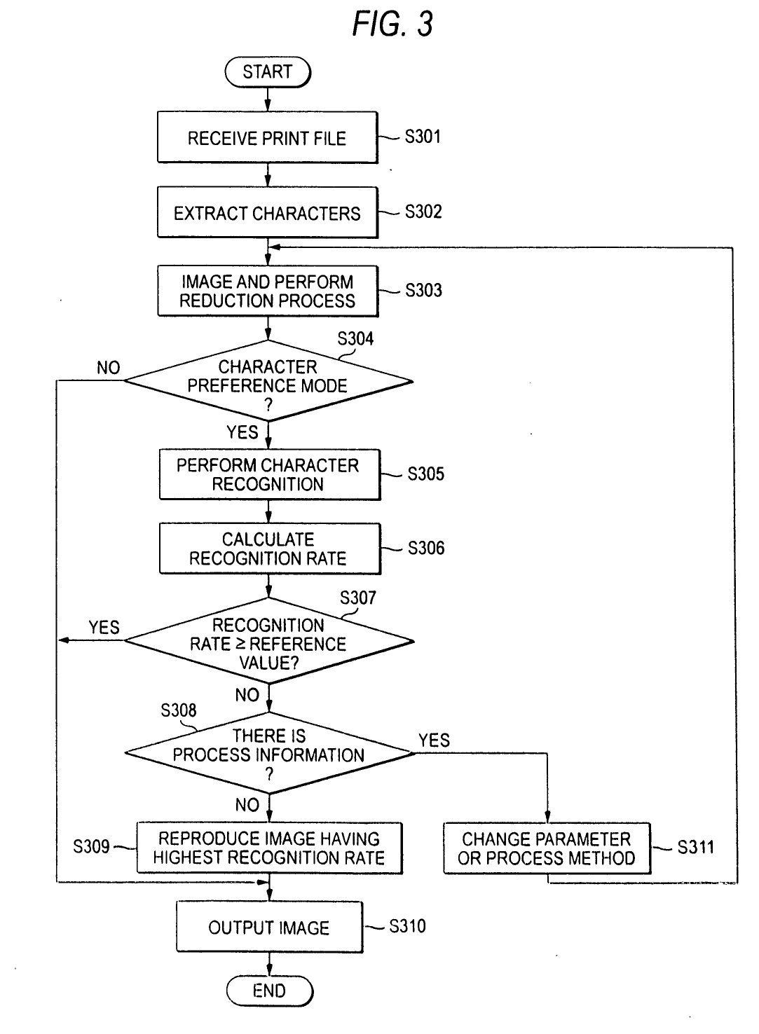

FIG. 3 is a flow chart showing an example of the operation of this exemplary embodiment.

When a print file is sent from the client 104, the reception unit 201 in the controller 102 receives the print file (step 301).

The received print file is passed from the reception unit 201 to the character extraction unit 202, and the character extraction unit 202 analyzes the print file to extract character information (step 302). Meanwhile, the print file is also passed to the imaging unit 203. The imaging unit 203 analyzes the print file to converts it into an image, and at that time, it reduces the image to a size specified by the header information of the print file (step 303).

Next, the imaging unit 203 determines as to whether or not a mode instructed by the print file is “character preference” (step 304). It is considered that the “character preference” mode will be selected by, for example, a user who wishes to make characters readable or easy to read even if somewhat a long process time is required in reducing.

If the selected mode is not “character preference,” the imaging unit 203 outputs the image generated at step 303 as it is to the output device 103 (step 310).

If the selected mode is “character preference,” the imaging unit 203 passes control to the character recognition unit 206. Then, the character recognition unit 206 performs the character recognition for the reduced image using a character recognition function that is used in OCR (step 305). Thereafter, the recognition rate calculating unit 207 compares the character information extracted at step 302 and the character information recognized at step 305, to calculate the recognition rate (step 306). For example, the recognition rate calculating unit 207 determines as to whether or not the characters at certain print positions that are extracted at step 302 match the characters at the same print positions that are recognized at step 305, and employs the match ratio as the recognition rate.

Next, the determination unit 208 determines as to whether or not this calculate recognition rate is equal to or greater than the reference value that has been set by the user as the expected value (step 307).

If the recognition rate is equal to or higher than the reference value, it means that the reduced image in which the characters are easy to read has been obtained by the imaging and the method of the reduction process at this time. Therefore, the determination unit 208 instructs the imaging unit 203 to output the reduced image produced at step 303 as it is. As a result, the imaging unit 203 outputs the image produced at step 303 to the output device 103 (step 310).

If the recognition rate is less than the reference value, the determination unit 208 instructs the imaging unit 203 to carry out the imaging using another process information. It is noted, however, that there is a limit to the number of patterns of the process information stored in the process information storing unit 205. Therefore, the imaging unit 203 determines as to whether or not there is process information that has not yet been tried (step 308).

If there is process information that has not yet been tried, the imaging unit 203 changes the parameter or the process method (step 311). The changing of the parameter may be, for example, changing a parameter of the edge-emphasizing process so as to make an image sharper during the reduction process (change in a boundary between a bright portion and a dark portion in an image is made abrupt). Other examples include reducing a density of the hatch pattern and reducing a density of data that form a background when the image information is layer-processed. In addition, examples of changing the process method include changing a font before and after the reduction process, or allowing a character to be thickened. It is noted that changing a parameter or the process method is carried out by successively selecting the parameters or the process methods stored in the process information storing unit 205. Then, when the parameter or the process method is changed, the process returns to step 303.

If there is no process information that has not yet been tried, the imaging unit 203 reproduces the reduced image having the highest recognition rate (but not exceeding the reference value) among the reduced images that have been generated, and stores the output image in a storage memory (step 309). It is noted that the imaging unit 203 stores a correspondence relation between the parameter or the process method and the recognition rate in a memory each time the parameter or the process method is changed and the recognition rate is calculated, for the case where such a process becomes necessary.

Next, changing the parameter or the process method in reduction printing will be described in detail.

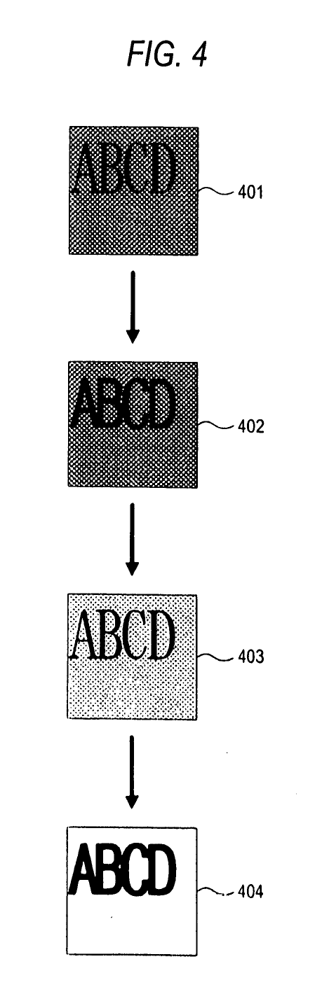

FIG. 4 shows one example of the changing of an image reduction parameter and the imaging processing method.

Here, it is assumed that an image 401 is generated by a normal process in the case where characters are on a hatch pattern. In a reduced image, each one dot of the hatch pattern becomes large relative to the characters, and therefore, there arise situations in which the characters are completely buried in the background or in which, although the characters are not completely buried, it is difficult to distinguish the characters and the background from each other. As a result, proper results cannot be obtained by T/I separation and character recognition cannot be carried out. Therefore, the recognition rate obtained in step 306 becomes low.

Next, it is assumed that a font of the image 401 is changed to generate an image 402. The process information storing unit 205 stores an instruction that a font and a hatch pattern such as the image 402 should be selected if character recognition cannot be carried out for a font and a hatch pattern such as the image 401. Thereby, the font and hatch pattern such as the image 402 is selected at step 311. However, in this case as well, the recognition rate remains poor because proper results cannot be obtained by T/I separation.

Next, it is assumed that a color of the hatch pattern in the image 402 is lightened to generate an image 403. The process information storing unit 205 stores an instruction that a font and a hatch pattern such as the image 403 should be selected if character recognition cannot be carried out for the font and hatch pattern such as the image 402. Thereby, a font and a hatch pattern such as the image 403 are selected at step 311. In this case, although proper results can be obtained by the T/I separation, each one dot in the hatch pattern is still large relative to the characters. Therefore, the character recognition tends to result in misrecognition. When the characters are in a black color and the hatch pattern is in another color, the black color is extracted by lightening the color of the hatch pattern, and proper results also tend to be obtained by T/I separation. Therefore, proper results are obtained in the character recognition as well, but the recognition rate becomes such a degree that does not exceed the reference value.

Subsequently, it is assumed that the font of the image 403 is changed and at the same time a size of each one dot of the hatch pattern is reduced to generate an image 404. The process information storing unit 205 stores an instruction that a font and a hatch pattern such as the image 404 should be selected if character recognition cannot be carried out for the font and the hatch pattern such as the image 403. Thereby, the font and the hatch pattern such as the image 404 are selected at step 311. In this case, the features of the characters become easily recognized. Therefore, the recognition rate exceeds the reference value, allowing the image to be output.

### SECOND EXEMPLARY EMBODIMENT

First, the configuration of the controller 102 according to a second exemplary embodiment will be described.

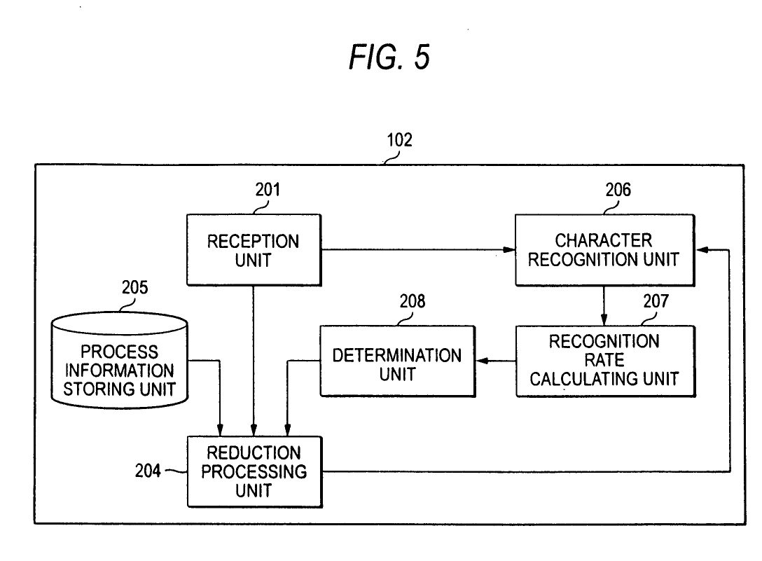

FIG. 5 is a diagram showing the configuration of the controller 102. It is noted that components with the same names as those in the controller 102 shown in FIG. 2 are designated by the same reference numerals.

In this exemplary embodiment, the controller 102 includes a reception unit 201 for receiving a scanned image, and a reduction processing unit 204 for generating a reduced image by reducing the scanned image. The controller 102 also includes a process information storing unit 205 for storing information that specifies a process content of the reduction processing unit 204, and a character recognition unit 206 for recognizing character information from the scanned image received by the reception unit 201 and the reduced image produced by the reduction processing unit 204. The controller 102 further includes a recognition rate calculating unit 207 for calculating a recognition rate by comparing the character information recognized from the scanned image by the character recognition unit 206 and the character information recognized from the reduced image by the character recognition unit 206, and a determination unit 208 for determining, based on the recognition rate, which the reduced image generated by the reduction processing unit 204 should be output as it is or a reduced image should be generated again with process information being changed.

The reception unit 201 receives, for example, a scanned image obtained by scanning an original document sheet by the input device 101, as an example of the image information. In this exemplary embodiment, the reception unit 201 is provided as an example of a reception unit. In addition, the scanned image is used as an example of the image information read by an image reading device.

The reduction processing unit 204 performs a reduction process for the scanned image, for example, according to a reduction rate specified during scanning of the original document sheet. In this exemplary embodiment, the reduction processing unit 204 is provided as an example of a reduction processing unit.

The process information storing unit 205 stores parameters in reduction of an image, as the process information that specifies process contents in the reduction processing unit 204. Here, examples of the parameters in reduction of an image include a density of a background image (hatch pattern or the like) and an emphasis degree of an edge of a character or a region contained in the image information. Furthermore, the process information storing unit 205 adds information of selection order to the process information and stores the resulting information. This selection order may be determined, for example, according to a pattern (type) of misrecognition obtained as a result of the character recognition. In addition, the information of such selection order may be determined for each type of printers.

The character recognition unit 206 performs T/I separation for the scanned image received by the reception unit 201 and the reduced image generated by the reduction processing unit 204, and recognizes character information from character regions of the respective images. In this exemplary embodiment, the character recognition unit 206 is provided as an example of the configuration which serves as both of the first character recognition unit and the second character recognition unit, and as an example of the character recognition unit. The character recognition unit 206 also serves as an example of a character separating unit for separating a character region. The character recognition unit 206 also recognizes information relating to print positions of characters when recognizing the character information.

The recognition rate calculating unit 207 compares the character information recognized from the scanned image by the character recognition unit 206 and that from the reduced image by the character recognition unit 206, and calculates a recognition rate. Here, the term “recognition rate” refers to a match ratio between the character information recognized from the scanned image and the character information recognized from the reduced image. For example, score “1” is given if each character recognized from the scanned image is also recognized from the reduced image, whereas score “0” is given if each character recognized from the scanned image is not recognized from the reduced image. Then, the total of the scores for all the characters recognized from the scanned image is obtained, and the resulting value is divided by the number of the characters. The value thus obtained is employed as the recognition rate. In this exemplary embodiment, the recognition rate is used as an example of a relation between the character information recognized by the first character recognition unit and the character information recognized by the second character recognition unit. In addition, the recognition rate calculating unit 207 is provided as an example of a status detecting unit for detecting this relation (the status of recognition).

The determination unit 208 compares the recognition rate calculated by the recognition rate calculating unit 207 with a reference value that is an example of a predetermined threshold value. If the recognition rate is equal to or greater than the reference value, the determination unit 208 instructs the reduction processing unit 204 to output the image at that time. Also, if the recognition rate is less than the reference value, the determination unit 208 instructs the reduction processing unit 204 to generate a reduced image again by changing the process information. In this exemplary embodiment, the determination unit 208 is provided as an example of a process content changing unit. It is noted that the determination unit 208 changes a subsequent process depending on which the recognition rate is less than the reference value or equal to or greater than the reference value. However, the determination unit 208 may change a subsequent process depending on which the recognition rate is greater than the reference value or equal to or less than the reference value.

Next, the operation of this exemplary embodiment will be described.

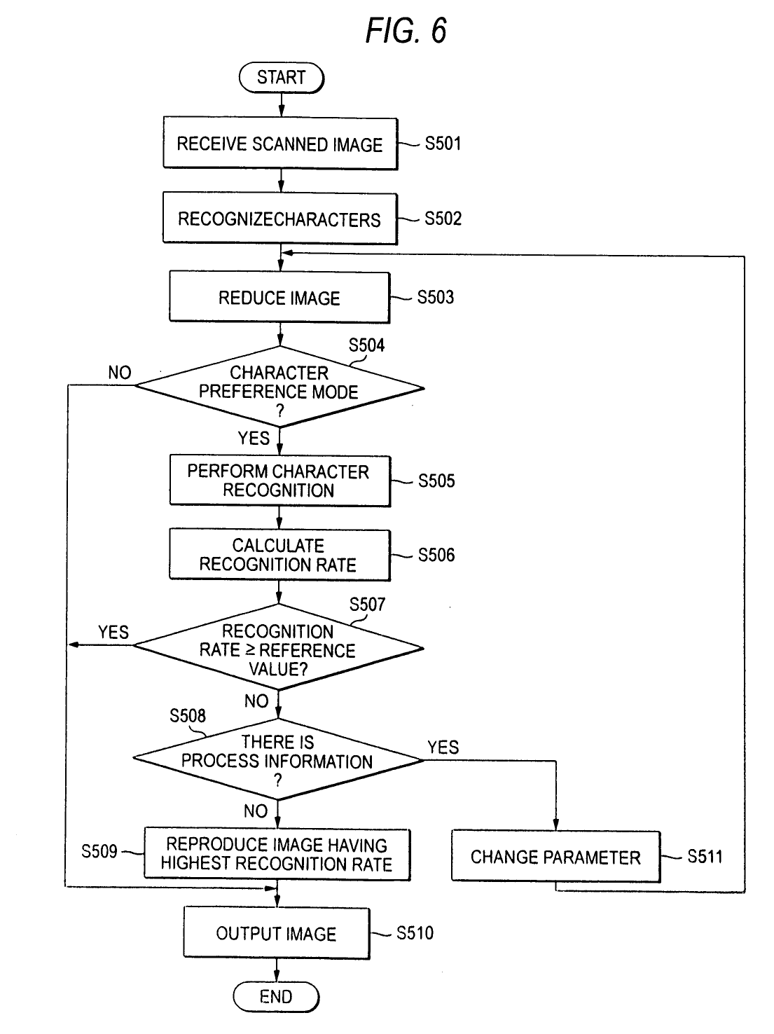

FIG. 6 is a flow chart showing one example of the operation of this exemplary embodiment.

When copying is started, the input device 101 scans an original document sheet, and the reception unit 201 in the controller 102 receives the scanned image obtained by the scanning (step 501).

The received scanned image is passed from the reception unit 201 to the character recognition unit 206, and the character recognition unit 206 performs the character recognition for the scanned image using the character recognition function used in OCR (step 502). Meanwhile, the scanned image is also passed to the reduction processing unit 204, and the reduction processing unit 204 reduces the scanned image to a predetermined size (step 503).

Next, the reduction processing unit 204 determines as to whether or not a mode specified in the scanning is “character preference” (step 504). It is considered that the “character preference” mode will be selected by, for example, a user who wishes to make characters readable or easy to read even if somewhat a long process time is required in reducing.

If the specified mode is not “character preference,” the reduction processing unit 204 outputs the image generated at step 503 as it is to the output device 103 (step 510).

If the specified mode is “character preference,” the reduction processing unit 204 passes control to the character recognition unit 206. Then, the character recognition unit 206 performs the character recognition for the reduced image using the character recognition function that is used in OCR (step 505). Thereafter, the recognition rate calculating unit 207 compares the character information recognized at step 502 and the character information recognized at step 505, and calculates the recognition rate (step 506). For example, the recognition rate calculating unit 207 determines as to whether or not characters at certain print positions that have been recognized at step 502 match characters at the same print positions that have been recognized at step 505, and employs the match ratio as the recognition rate.

Next, the determination unit 208 determines as to whether or not this calculate recognition rate is equal to or greater than the reference value that has been set by the user as the expected value (step 507).

If the recognition rate is equal to or higher than the reference value, it means that a reduced image in which the characters are easy to read has been obtained by the method of the reduction process this time. Therefore, the determination unit 208 instructs the reduction processing unit 204 to output the reduced image produced at step 503 as it is. Thereby, the reduction processing unit 204 outputs the image generated at step 503 to the output device 103 (step 510).

If the recognition rate is less than the reference value, the determination unit 208 instructs the reduction processing 204 to carry out the reduction process using another process information. It is noted, however, that there is a limit to the number of patterns of the process information stored in the process information storing unit 205. Therefore, the reduction processing unit 204 determines as to whether or not there is process information that has not yet been tried (step 508).

If there is process information that has not yet been tried, the reduction processing unit 204 changes a parameter (step 511). The changing of a parameter may be, for example, changing a parameter of the edge-emphasizing process so as to be sharper in the reduction process (change in a boundary between a bright portion and a dark portion in an image is made abrupt). Other examples include reducing a density of the hatch pattern and reducing a density of data that form a background when the image information is layer-processed. It is noted that changing a parameter is carried out by successively selecting the parameters stored in the process information storing unit 205. Then, when the parameter is changed, the process returns to step 503.

If there is no process information that has not yet been tried, the reduction processing unit 204 generates the reduced image having the highest recognition rate (but not exceeding the reference value) among the reduced images that have been generated, and stores the output image in a storage memory (step 509). It is noted that the reduction processing unit 204 stores a correspondence relation between the parameter and the recognition rate in a memory each time the parameter is changed and the recognition rate is calculated, for the case where such a process becomes necessary.

Next, changing a parameter in reduction copying will be described in detail.

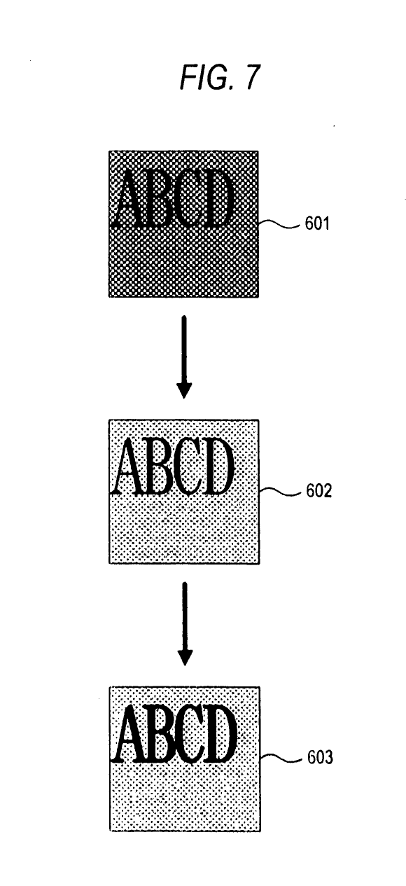

FIG. 7 shows one example of the changing of an image reduction parameter.

It is assumed that an image 601 is generated by a normal reduction process when characters are on a hatch pattern. In a reduced image, each one dot of the hatch pattern becomes large relative to the characters. Therefore, there arises a situation in which it is difficult to distinguish the characters and the background from each other. As a result, proper results cannot be obtained by T/I separation. Thus, character recognition cannot be carried out.

Next, it is assumed that T/I separation is carried out for the image 601 that has not been reduced yet and a color is lightened in the reduction of the image portion, whereby an image 602 is generated. The process information storing unit 205 stores an instruction that a font and a hatch pattern such as the image 602 should be selected if character recognition cannot be carried out for the font and the hatch pattern such as the image 601. Thereby, the font and the hatch pattern such as the image 602 are selected at step 511. In this case, although proper results can be obtained by the T/I separation, the character line is thin and it is difficult find features of the characters. Therefore, the character recognition tends to result in misrecognition.

Next, it is assumed that when the character portion of the image 602 is reduced, edge emphasizing is carried out by image processing to generate an image 603. The process information storing unit 205 stores an instruction that the edge emphasizing such as the image 603 should be selected if character recognition cannot be carried out for the font and the hatch pattern such as the image 602. Thereby, the parameter of the edge emphasizing such as the image 603 is selected at step 511. In this case, the features of the characters become easily recognized. Therefore, the recognition rate exceeds the reference value, allowing the image to be output.

It is noted that, in the second exemplary embodiment, it is assumed that only the image reduction parameter is changed if the recognition rate is less than the reference value. Therefore, the changing of the typeface of the characters has not been illustrated as a specific example. However, for example, such a configuration may be adopted in which a typeface of characters is changed by carrying out a process of replacing a character image obtained by the T/I separation with a character image having a different typeface.

The image processing according to this exemplary embodiment may be implemented by any computer other than the controller 102 in the system as shown in FIG. 1. For this reason, assuming that this image processing is implemented by a computer 90, the hardware configuration will be described below.

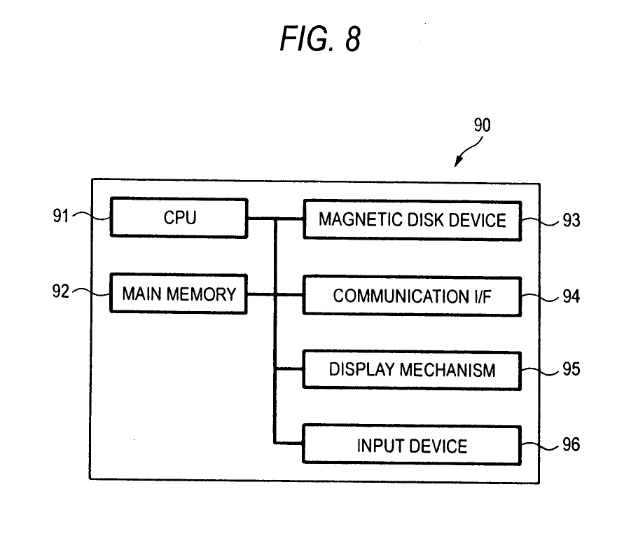

FIG. 8 is a diagram showing the hardware configuration of a computer 90.

As shown in the figure, the computer 90 includes a CPU (Central Processing Unit) 91, which serves as computing device, and a main memory 92 and a magnetic disk device (HDD: Hard Disk Drive) 93, which serve as a storage unit. Here, the CPU 91 executes various software programs such as an OS (Operating System) and applications to realize the above-described various capabilities. Moreover, the main memory 92 is a storage region for storing various software programs and data used for execution thereof, and the magnetic disk device 93 is a storage region for storing input data to the various software programs and output data from the various software programs.

The computer 90 further has a communication I/F 94 for performing communication with outside, a display mechanism 95 having a video memory, a display, and so forth, and an input device 96 having a keyboard, a mouse, and the like.

It is noted that a program for implementing the exemplary embodiments may of course be provided through a communication unit as well as in a storage medium such as a CD-ROM that stores the program.

The foregoing description of the exemplary embodiments of the invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image processing apparatus comprising:
a reception unit that receives image information;
a first character recognition unit that recognizes character information from the image information received by the reception unit;
a reduction processing unit that performs a reduction process for the image information received by the reception unit;
a second character recognition unit that recognizes character information from the image information for which the reduction processing unit performs the reduction process;
a status detecting unit that detects a relation between the character information recognized by the first character recognition unit and the character information recognized by the second character recognition unit; and
a process content changing unit that changes a process content of the reduction process performed by the reduction processing unit, according to the relation detected by the status detecting unit.

2. The image processing device according to claim 1, wherein
the status detecting unit detects a recognition rate as the relation,
the recognition rate is a match ratio between the character information recognized by the first character recognition unit and the character information recognized by the second character recognition unit, and
if the recognition rate detected by the status detecting unit is equal to or less than a predetermined threshold value, the process content changing unit changes the process content of the reduction process performed by the reduction processing unit.

3. The image processing device according to claim 1, wherein the process content changing unit changes the process content relating to a typeface of a character contained in the image information.

4. The image processing device according to claim 1, wherein the process content changing unit changes the process content relating to a density of a background image contained in the image information.

5. The image processing device according to claim 1, wherein the process content changing unit changes the process content relating to an emphasis degree of an edge of a character or a region contained in the image information.

6. The image processing device according to claim 1, wherein the process content changing unit changes the process content of the reduction process performed by the reduction processing unit, according to a type of misrecognition of the character information by the second character recognition unit.

7. An image forming apparatus comprising:
a reception unit that receives first image information;
a character extraction unit that extracts character information from the first image information received by the reception unit;
an imaging unit that images the first image information received by the reception unit, to generate second image information;
a reduction processing unit that performs a reduction process for the second image information, which is generated by the imaging unit;
a character recognition unit that recognizes character information from the second image information for which the reduction process is performed by the reduction processing unit;
a process content changing unit that changes at least one of (i) a process content of the reduction process performed by the reduction processing unit and (ii) a process content of the imaging by the imaging unit, according to a relation between the character information extracted by the character extraction unit and the character information recognized by the character recognition unit; and
an image forming unit that forms an image on a recording medium using the second image information for which the reduction process is performed by the reduction processing unit.

8. An image forming apparatus comprising:
a reception unit that receives image information read by an image reading device;
a character separating unit that separates a character region from the image information received by the reception unit;
a reduction processing unit that performs a reduction process for the image information received by the reception unit;
a character recognition unit that recognizes first character information from the character region separated by the character separating unit and recognizes second character information from the image information for which the reduction process is performed by the reduction processing unit;
a process content changing unit that changes a process content of the reduction process performed by the reduction processing unit, according to a relation between the first character information and the second character information; and
an image forming unit that forms an image on a recording medium using the image information for which the reduction process is performed by the reduction processing unit.

9. A computer-readable medium storing a program that causes a computer to execute image processing, the image processing comprising:
receiving image information;
recognizing first character information from the received image information;
performing a reduction process for the received image information;
recognizing second character information from the image information for which the reduction process is performed;
detecting a relation between the first character information and the second character information; and
changing a process content of the reduction process according to the detected relation.
